(19) United States
(12) Patent Application Publication
(10) Pub. No.: US 2006/0024064 A1
(43) Pub. Date: Feb. 2, 2006

(54) Method for transmitting data signals and additional signals in an optical network

(76) Inventors: Nancy Hecker, Munchen, DE (US); Sander Jansen, EV Bunnik (NL); Dirk van den Borne, BN Bladel (NL)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/191,534

(22) Filed: Jul. 28, 2005

(30) Foreign Application Priority Data
Jul. 28, 2004 (DE) 10 2004 036 493.1

(51) Int. Cl. H04B 10/00

(52) U.S. Cl. 398/152

(57) ABSTRACT

The transmission of a data signal (DS) in the form of data packets takes place by means of angular modulation, preferably two or three stage difference phase modulation. The header (HEAD) is transmitted by means of polarization modulation. An additional channel formed in this way is also available for the transmission of additional information. To separate the header (HEAD), the multiplex signal (DHS) is aligned in a specific polarization level, so that the header can be separated without any problem. A new header can be added without having to convert the data signal into an electrical signal beforehand.

### CROSS REFERENCE TO RELATED APPLICATIONS

This application claims priority to the German application No. 10 2004 036 493.1, filed Jul. 28, 2004 and which is incorporated by reference herein in its entirety.

### FIELD OF INVENTION

The method relates to the transmission of data signals and additional signals or an associated header in an optical network and a suitable arrangement therefor.

### SUMMARY OF THE INVENTION

Optical networks have hitherto mostly been designed as point-to-point connections. Future networks will however be designed in a more flexible manner. In addition to the hitherto conventional transmission of optical data in permanently assigned channels, methods for the transmission of optical data packets will emerge which are known as burst switching and packet switching. With packet transmission each data packet needs to be provided with a so-called header, which prefixes the actual information, the data signal, of the so-called ‘payload’. The packet end can be indicated by means of a further label.

The prefixing of the header signifies a loss of transmission capacity. One possibility of avoiding this is an additional modulation of the data signal for the transmission of the header. It is difficult however to transmit this information via amplifiers and regenerators without damaging the signal quality. On the other hand, the transmission of the header together with the payload, known as ‘optical labeling’ ensures a considerable improvement in the transmission capacity.

The conventional transmission of the header via a separate (electrical) network, known today as burst switching, can also be avoided in a similar manner.

One fundamental problem with the optical signal transmission is also that of extracting the header. The conversion of the header and payload into electrical signals is associated with considerable costs and thus involves a reduction in the transmission capacity as a result of additional delays.

In a STOLAS project using the polarization multiplex method, payload and header are transmitted in orthogonal polarization levels. This allows the header to be separated in a simple manner and to be evaluated in the electrical area whilst the payload remains unchanged as an optical signal. This project proposes to transmit the information using amplitude modulation (ASK), whilst difference phase modulation (DPSK) or frequency modulation (SK) is provided for the header information. The effectiveness of the selected methods is however minimal. With a high modulation index, an orthogonal polarized signal is only generated if the data signal comprises a logical 1, as this signal supplies the carrier for the header transmission. An amplitude modulated signal is used in order to have a carrier signal available at all times, said carrier signal comprising two different amplitude stages, which are greater than zero. This method nevertheless results in a poor signal-to-noise ratio.

IEEE Photonics Technology Letters, Vol. 16, No. 7, July 2004, pages 1766-1768 describes a transmission method in which difference phase modulation and polarization modulation (pole shift keying) are combined. The demodulation device works with rectified components of the signals transmitted in the two polarization levels. The sensitivity is correspondingly lower and unequal delays of the polarized signals once again reduce the transmission performance during phase difference modulation.

The object of the invention is thus to specify an improved method for the transmission of the header and/or of additional information. Furthermore, arrangements for extracting and adding the header/the additional information are also to be described.

The object is achieved by the claims.

A particular advantage of the known method is that only one carrier signal is ever transmitted, said carrier signal comprising different polarizations. In this way, an optimal signal-to-noise ratio is achieved.

The combination of angular modulation and polarization modulation enables an easy extraction of the header/additional information in the optical domains, without the need for the data signal to be converted into the electrical domains. Similarly, a new header can be added to the optical data signal.

The invention is described in more detail with reference to exemplary embodiments.

### BRIEF DESCRIPTION OF THE DRAWINGS

FIG. 1 shows a modulation device,

FIG. 2 shows the modulation with a data signal and the header FIG. 3 shows the multiplex signal,

FIG. 4 shows a first arrangement for the header processing,

FIG. 5 shows a variant for adding a new [lacuna] with header, and

FIG. 6 shows a variant of this arrangement.

### DETAILED DESCRIPTION OF THE INVENTION

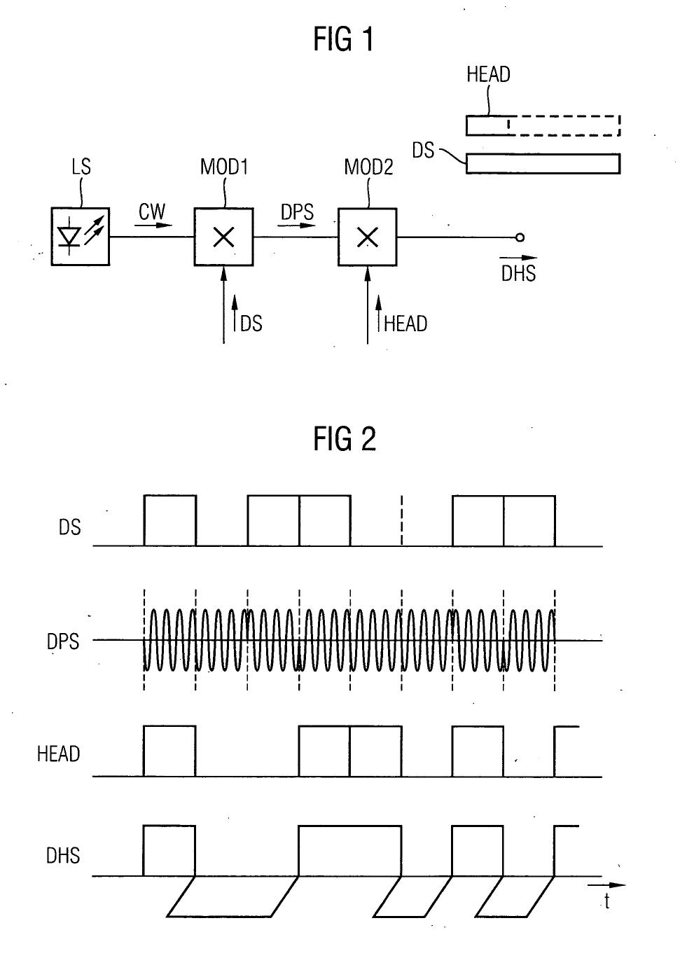

FIG. 1 shows a transmission device. A data signal is to be transmitted in the form of data bursts, to which is assigned a header in each instance. The data signal can thus be present in the form of so-called data packets or IP packets. This part of the transmission device is known and is not part of the invention which relates to the transmission method.

A laser LS generates a carrier signal plus CW which is angular modulated in a first modulator M0D1 by the data signal DS. It is thus advantageous here to use the fail-safe difference phase modulation. The angular modulated signal DPS is supplied to a second modulator M0D2, which polarizes it in accordance with the binary statuses of an additional signal HEAD. In this way, with a logical ‘1’ of the header for example, the polarization is not changed and with a logical ‘0’, the polarization is rotated about 90°. The multiplex signal DHS generated in this way is then combined if necessary with further multiplex signals to form a wavelength multiplex signal, and transmitted to a recipient via a fiber optic cable.

The method can be configured in particular for the transmission of additional signals or data bursts. Any number of additional signals, e.g. a service and monitoring signal, can be transmitted in a service channel or in the case of the transmission of data bursts the header can be transmitted instead of an additional signal of the header. The differences relating to the invention with the transmission of data bursts with header and data signals with service signals are minimal so that further explanations can only take place on the basis of the transmission of data bursts. A data burst containing data DS of this type and header information HEAD is displayed at the output of the transmission device. As only minimal header or additional information is transmitted in comparison with the data, its data rate can be more marginal. If contrastingly the header information is soon to be present, the same data rate is selected.

FIG. 2 shows the modulation procedures in detail. The binary data signal DS modulates the carrier signal CW and generates an angular modulated data signal, in this case the difference modulated data signal DPS. A logical 1 generates a phase jump of 180° for example. In contrast no phase jump occurs with a logical 0. With each 0-bit of the header HEAD, the polarization is changed for instance and the (polarization) multiplex signal DHS is thereby generated.

The multiplex signal DHS and the associated information, the data signal DS, are displayed again in detail in FIG. 3. The polarization change PA takes place according to the coordinates system displayed. With a logical 0 of the header, the polarization level of the x-t-level in the y-t-level is “pivoted”. In principal, the header or the additional information can be transmitted by means of angular modulation and the data signal by means of POLSK. However the recovery and the readdition of header or service information then becomes significantly more complicated.

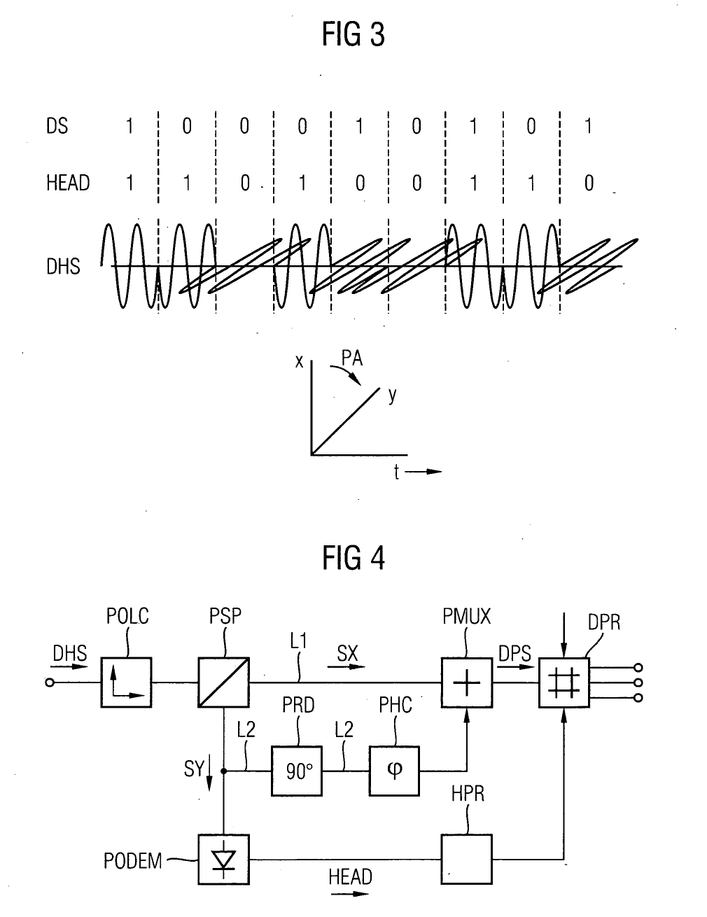

FIG. 4 shows a reception arrangement for the decoding of the header and for the recovery of the angular modulated signal. The receiving multiplex signal DHS is first fed to a polarization actuator POLC, which carries out a predetermined polarization setting. The subdivision takes place in two orthogonal signal components SX and SY in the polarization filter PSP (polarization splitter) arranged downstream. Each of these signal components (or both) can be used to recover the header in a POLSK demodulator PODEM, a photo diode, which registers the presence and absence of an optical carrier. The header is evaluated in a header processor device HPR.

To recover the angular modulated signal DPS, of a difference phase signal in this instance, the changes of the polarization modulator M0D2 must be reversed. This is done by means of the polarization rotator PRD (or by a further polarization modulator), which is switched on in the signal line L2. A phase regulator PHC connected in series with this allows the phase-precise addition of the signal component SY with the signal component SX. This is required with phase modulation in order to enable an optimum decoding of the data signal. When the multiplex signal does not need to be demodulated, the phase correction can be dispensed with. The signal component SY is combined with the signal component SX, in whose signal line L1 a delay element (not shown) is switched, in a polarization multiplexer (summing unit) PMUZ to the difference phase signal DPS. This signal further contains the data signal, the data bursts of which are routed from now on into a processing unit DPR, e.g. a switching device or reception device, based on the recovered header information HEAD.

To ensure sufficient time for the evaluation of the header, the signal component transmitting the data signal must either be delayed or the header must be forwarded in advance.

If the processing device is a cross connector for example, a newly generated time multiplex signal can be output, the data packets of which are provided in a polarization modulator POMOD with a new header, without the payload having been converted in advance into an electrical signal.

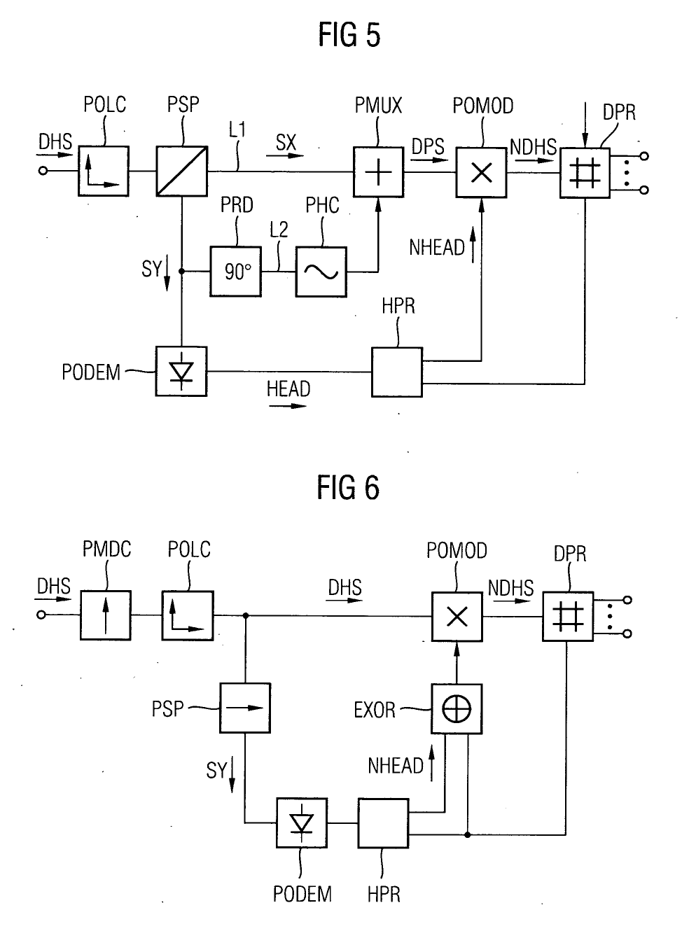

FIG. 5 shows a reception arrangement at a POLSK modulator POMOD (polarization shift keying) to add a new header NHEAD. The new header can be remodulated after the angular modulated signal DPS has been reestablished. The new multiplex signal NDHS is then further processed and redirected.

The reception arrangement according to FIG. 6 achieves the same result by means of an EXOR link of the old header HEAD with the new header NHEAD in an EXOR element. The setting of the polarization and the recovery of at least one signal component takes place as in FIG. 5, in a similar manner to the recovery of the header. The multiplex signal DHS nevertheless remains unchanged and is fed to the PSK modulator POMOD. The polarization backer HPR and the phase regulator PHR are not required, as the signal components are not subdivided and the phase correction between the signal components is dispensed with. If necessary, the delay time difference can also be dispensed with by means of a PMD compensator PMDC. With this arrangement, as already mentioned, the header is EXOR linked to the new header and the multiplex signal DHS is POLSK modulated according to the new header. The output signal of the EXOR element determines the polarization of the data bits influenced by the old header HEAD, by controlling the POLSK modulator POMOD. Insignificant details such as delay elements in the links which are required due to the required recovery and further processing of the header for example were not displayed.

The exemplary embodiments arise from the transmission of data packets. An additional channel for the transmission of service and monitoring data can naturally also be formed in the same manner. The term header can thus be replaced by the term additional information, with which the additional information can naturally also be transmitted with essentially lower data rates.

The invention further comprises a reception device for an optical polarization multiplex signal containing a data signal and an additional signal, wherein
a received polarization multiplex signal is fed to a polarization actuator, which sets a predetermined polarization, wherein
a polarization splitter arranged downstream of the polarization actuator separates the multiplex signal into two orthogonal signal components, wherein
at least one of the signal components is fed to a POLSK-demodulator, wherein
the signal components are fed to a polarization multiplexer (PMUX) via separate optical lines, wherein
a polarization resetter and/or if necessary a phase regulator are arranged in one of the lines, wherein
the signal component is then combined into an angular modulated data signal by means of the polarization multiplexer, and wherein the re-extracted angular modulated data signal is fed to a processing device.

In the reception device a POLSK-modulator is advantageously arranged downstream of the polarization multiplexer, said POLSK-modulator generating a new multiplex signal by means of the polarization modulation of the angular modulated data signal with a new header or an additional signal.

The invention further comprises a reception device for an optical polarization multiplex signal containing a data signal and a header, wherein
a received multiplex signal is fed to a polarization actuator, wherein
the polarization actuator sets a predetermined polarization, wherein
a polarization splitter arranged downstream of the polarization actuator emits two orthogonal signal components of the optical multiplex signal, wherein
at least one of the signal components for recovering the header is fed to a POLSK-demodulator, wherein
the polarization multiplex signal is fed to a POLSK-modulator, wherein
both the recovered header and also a new header are fed to an EXOR-element, the output signal of which controls, the POLSK-modulator and thus generates a new multiplex signal with the new header.

1-12. (canceled)

13. A method for transmitting data bursts containing a data signal and a header via optical connections, the method comprising:
applying an angular modulation to an optical carrier signal by the data signal;
applying a polarization modulation to the angularly modulated optical carrier signal by the header to generate a multiplex signal; and
transmitting the multiplex signal.

14. The method according to claim 13, wherein the optical carrier signal is difference phase modulated by the data signal.

15. The method according to claim 14, wherein the optical carrier signal is modulated by the data signal by means of two-stage difference phase modulation.

16. The method according to claim 13, wherein the polarization of the multiplex signal is controlled on a receiver side, wherein the multiplex signal is subdivided into two orthogonal polarized signal components, and wherein at least one of the signal components is demodulated to obtain the header.

17. The method according to claim 16, wherein the two signal components are merged into a re-extracted angular modulated data signal.

18. The method according to claim 16, wherein the two signal components are demodulated to obtain the data signal.

19. The method according to claim 17, wherein the re-extracted angular modulated data signal is demodulated to obtain the data signal.

20. The method according to claim 17, wherein the re-extracted angular modulated data signal is polarization modulated with a new header.

21. A method for transmitting data signals and additional signals via optical connections, comprising:
applying an angular modulation to an optical carrier signal by a data signal;
applying a polarization modulation to the angularly modulated optical carrier signal by an additional signal to generate a multiplex signal; and
transmitting the multiplex signal.

22. The method according to claim 21, wherein the optical carrier signal (CW) is difference phase modulated by the data signal (DS).

23. The method according to claim 22, wherein the optical carrier signal is modulated by the data signal by means of two-stage difference phase modulation.

24. The method according to claim 21, wherein the polarization of the multiplex signal is controlled on a receiver side, wherein the multiplex signal is subdivided into two orthogonal polarized signal components, and wherein at least one of the signal components is demodulated to obtain the additional signal.

25. The method according to claim 24, wherein the two signal components are merged into a re-extracted angular modulated data signal.

26. The method according to claim 24, wherein the two signal components are demodulated to obtain the data signal.

27. The method according to claim 25, wherein the re-extracted angular modulated data signal is demodulated to obtain the data signal.

28. The method according to claim 25, wherein the re-extracted angular modulated data signal is polarization modulated with a new header.

29. An arrangement for transmitting a data signal and an additional signal by means of a polarization multiplex signal via optical connections, comprising:
an angular modulator; and
a polarization modulator, wherein
the angular modulator, which, as a modulator signal is fed a binary data signal and an optical carrier signal and the polarization modulator, which, as a modulation signal, is fed an additional signal, are connected in series.
